(19) United States
(12) Patent Application Publication
(10) Pub. No.: US 2009/0151790 A1
(43) Pub. Date: Jun. 18, 2009

(54) ELECTRO-MAGNETIC MULTI CHOKE POSITION VALVE

(75) Inventors: Priyesh Ranjan, Houston, TX (US); Don A. Hopmann, Alvin, TX (US); Luis E. Mendez, Houston, TX (US); Carl W. Stoesz, Houston, TX (US)

Correspondence Address: CANTOR COLBURN, LLP, 20 Church Street, 22nd Floor, Hartford, CT, 06103, US

(73) Assignee: BAKER HUGHES INCORPORATED, HOUSTON, TX (US)

(21) Appl. No.: 12/271,267

(22) Filed: Nov. 14, 2008

Related U.S. Application Data
(60) Provisional application No. 61/013,166, filed on Dec. 12, 2007.

(51) Int. Cl. F16K 11/14

(52) U.S. Cl. 137/1; 137/870

(57) ABSTRACT

An electromagnetic valving system includes a manifold having one or more flow passages therein; a sleeve disposed relative to the manifold so that movement of the sleeve inhibits or allows fluid flow relative to the manifold; and an electromagnet positioned relative to the sleeve such that a magnetic field generated by the at least one electromagnet produces a motive force in the sleeve and method.

### CROSS REFERENCE TO RELATED APPLICATION

The present application claims priority to U.S. Provisional Patent Application Ser. No. 61/013,166, filed Dec. 12, 2007, the entire contents of which are specifically incorporated herein by reference.

### BACKGROUND

In the hydrocarbon recovery industry, controlling fluid flow is among the most important and ubiquitous requirements for a well operator. There are certainly a plethora of mechanically based valve systems, hydraulically based valve systems, etc. Actuation of such systems is accomplished in many different ways for many different reasons, with the ultimate goal being to control flow in a manner that is desirable and effective for the ultimate purpose related to that specific control regime. While it is noted many systems already exist in the downhole industry and have been well tried and true, proven over the years and determinedly reliable, the art has always remain interested in alternative valving arrangements whereby a greater control density, or greater reliability, etc. is realized. Therefore the art will well receive the valving embodiments disclosed in this document.

### SUMMARY

An electromagnetic valving system includes a manifold having one or more flow passages therein; a sleeve disposed relative to the manifold so that movement of the sleeve inhibits or allows fluid flow relative to the manifold; and an electromagnet positioned relative to the sleeve such that a magnetic field generated by the at least one electromagnet produces a motive force in the sleeve.

A method for configuring fluid flow in a wellbore includes selecting a current polarity for an electromagnet in motive force generating communication with a moveable sleeve of a valving arrangement; and urging the sleeve to a selected position that facilitates or inhibits flow.

### BRIEF DESCRIPTION OF THE DRAWINGS

Referring now to the drawings wherein like elements are numbered alike in the several Figures:

FIG. 1 is a schematic side view of a first valving arrangement as disclosed herein;

FIG. 2 is a schematic view of an alternate port configuration;

FIG. 3 is a schematic view of another alternate port configuration;

FIG. 4 is a schematic view of another alternate port configuration;

FIG. 5 is a schematic view of another embodiment of the valving arrangement disclosed herein; and

FIG. 6 is a component view of the arrangement of FIG. 5.

### DETAILED DESCRIPTION

The valving system embodiments disclosed herein all employ magnetic fields, both permanent and temporary (e.g. electromagnetic, etc.), to position at least one valve in a selected condition of open or closed, or a selected position between open and closed, whereby a choked valve arrangement is achieved. Within the various embodiments disclosed herein, it will be appreciated by one of ordinary skill in the art that a substantial amount of control and tailoring of flow through the valve systems disclosed herein is available based upon the specific configurations of components of the valve systems as shown and described herein. It is also noted that reconfigurations of the components are also contemplated to tailor the ultimate system to a desired goal.

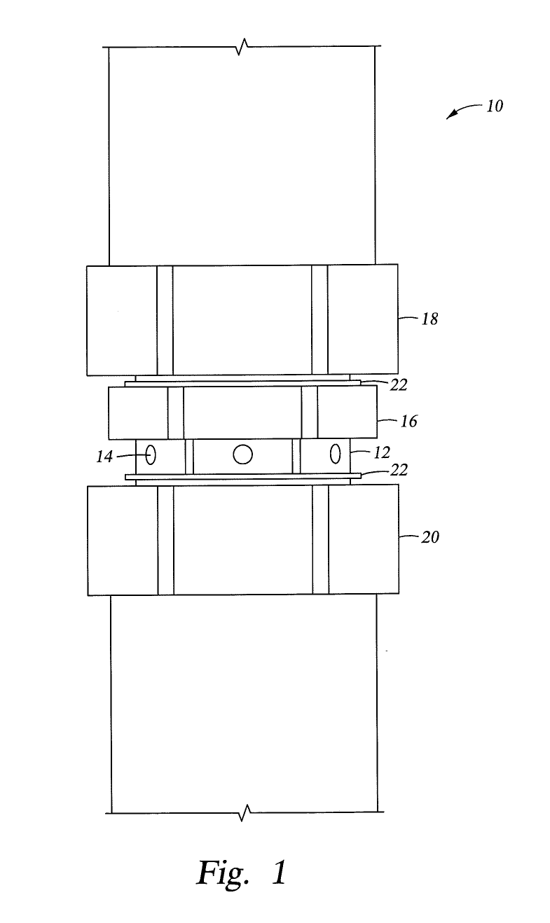

Referring to FIG. 1, a first embodiment of the magnetic valving system 10 is illustrated. Valve system 10 includes a manifold 12 having one or more flow passages such as ports 14 as shown, or grooves, recesses, channels, etc. located therein. A sleeve 16 is movably disposed adjacent to the manifold 12 so that sleeve 16 may be positioned to inhibit flow through the one or more ports 14 (“inhibit” meaning anything from a slight reduction in flow to a complete stoppage of flow) or facilitate such flow by being positioned so that flow from the one or more ports 14 may progress unimpeded. In the illustrated embodiment of FIG. 1, electromagnet 18 and electromagnet 20 are positioned on either axial end of sleeve 16 and the manifold 12. In such arrangement, a great deal of motive force can be applied to the sleeve 16 in order to move it to its intended position. Movement of the sleeve in a desired direction requires only a determination of which polarity current is needed to produce a field having the appropriate pole orientation. In an embodiment where the sleeve does have its own field, the electromagnet that is to create a pushing force on the sleeve requires an opposing field. To create the opposing field, current of a selected polarity is needed, the polarity of the current being directly related to the field polarity needed. The other of the two electromagnets will have the opposite polarity. It is to be understood, however, that a single electromagnet 18 or 20 could be utilized while maintaining the ability of the sleeve 16 to be positioned selectively and repetitively. The difference between the system illustrated in FIG. 1 and the system utilizing one electromagnet, is the degree of motive force available since where one electromagnet is utilized, the motive force on sleeve 16 can only be a pulling magnetic field or a pushing magnetic field. Both of these motivators (pulling and pushing), simultaneously, can only be achieved by using two electromagnets. Further, it is not to be missed that where a one time actuation is desirable, a single electromagnet and a sleeve constructed to not have its own magnetic field but to respond to one, will work. Such a sleeve is also selectively and repeatably actuable with two electromagnets 18 and 20 that are powered on one at a time instead of simultaneously as in FIG. 1.

Referring back to the FIG. 1 embodiment, sleeve 16 comprises at least one permanent magnet. The entire sleeve may be magnetized or several individual and permanent magnets may be attached to, embedded in, or otherwise formed by sleeve 16. It is also possible to utilize an electromagnet with sleeve 16. Regardless of the selected configuration just listed, sleeve 16 is endowed with a magnetic field. That field can then be exploited for greater motive force with respect to repositioning sleeve 16 by selecting a current direction in electromagnet 18 and electromagnet 20. For the greatest motive force in the embodiment, both electromagnet 18 and electromagnet 20 are actuated simultaneously with oppositely configured fields so that both an attractive force on sleeve 16 and a repelling force on sleeve 16 operate at the same time and put a motive force on the sleeve 16 in the same direction.

As alluded to above, while sleeve 16 has been identified as comprising permanent or electromagnets, it is also possible for sleeve 16 to merely comprise a magnetic material, which might be an iron-based material, for example, and not include permanent magnet(s) or one or more electromagnets. Such a configuration sleeve 16 is subject to an attractive force generated by electromagnet 18 or electromagnet 20 but would not be subject to a repulsive force generated by electromagnet 18 or electromagnet 20 since a repulsive force is not possible to generate without a magnetic field emanating from both objects. Accordingly, about half the actual motive force of the FIG. 1 embodiment would be imparted to sleeve 16 under such conditions.

Having been exposed to the foregoing disclosure and the FIG. 1 illustration, one of ordinary skill in the art will clearly appreciate that sleeve 16 can be shuttled back and forth (open/closed/or anywhere in between) between a position proximate electromagnet 18 and a position proximate electromagnet 20. Sleeve 16 may be maintained in such position by the maintenance of power in at least one of electromagnet 18 and electromagnet 20 to maintain at least one of the attractive field or the repulsive field (again, if it is to be the repulsive field that is maintained, the sleeve 16 must be endowed with its own magnetic field), if desired. Because electromagnets do require a substantial amount of power to maintain their electromagnetic field, however, it may be desirable to power down both electromagnets 18 and 20 for a period of time. In such event, one or more magnetic latches 22 may be incorporated in system 10 as illustrated in FIG. 1. In the event that the sleeve comprises a source for its own magnetic field, the latches 22 may be constructed of merely a magnetic material; alternatively, in the event that the sleeve 16 is of a magnetic material but not inclusive of a configuration that generates its own magnetic field, the latches 22 would need to be capable of generating a field of their own. This can be through the use of permanent magnets, or the latch itself could comprise a permanent magnet or the latches could include a coil so that an electromagnetic field could be generated. If the last embodiment is used, the only power savings is that the latch can have a smaller field because it is not intended to move another structure but rather only to hold it.

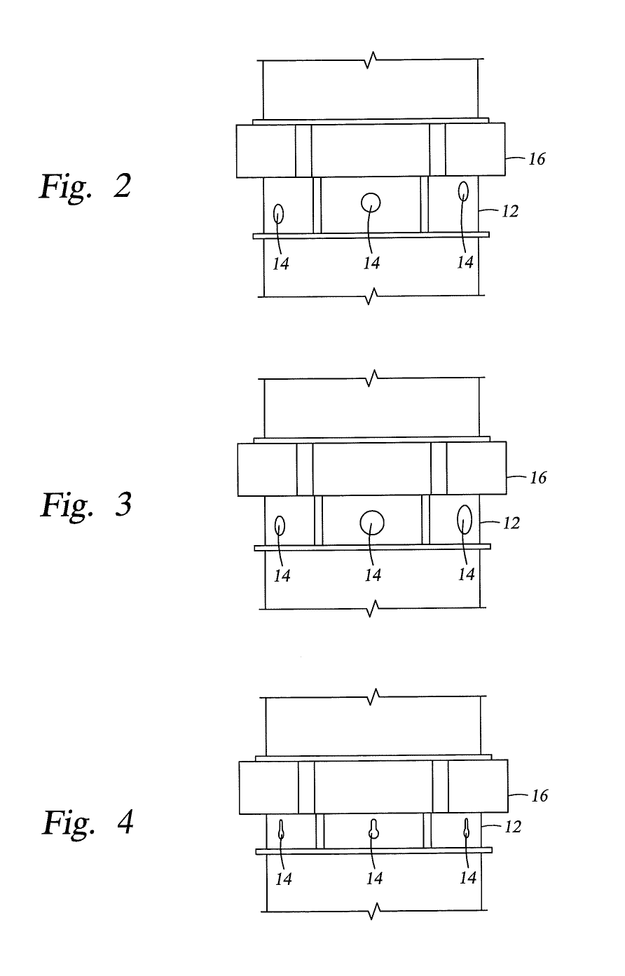

While FIG. 1 illustrates three ports 14 and the ports are all of the same dimensions, it is possible to have more ports in manifold 12, to have ports in different axial positions relative to manifold 12 (see FIG. 2), to have ports 14 of different sizes in manifold 12 (see FIG. 3), and to have ports of irregular shapes in manifold 12 (see FIG. 4). It is to be appreciated that the above configurations as shown may also be mixed and matched during the manufacturing of the manifold. Each of the possible configurations provide a means of controlling flow differently, which can be useful for different types of fluids or for different types of desired flow regimes. Flow ranges from an on or off condition, to a substantially infinitely variable flow regime as the sleeve may be actuated to stop where it is desired to stop thereby exposing some ports and not other ports or partially exposing some ports and not other ports, etc.

In the embodiment illustrated in FIGS. 1-4, the flow is radially directed. It can be either radially inwardly or radially outwardly. In other embodiments however, the flow can be directed by utilizing the sleeve not only as a valve plate but as a flow redirector.

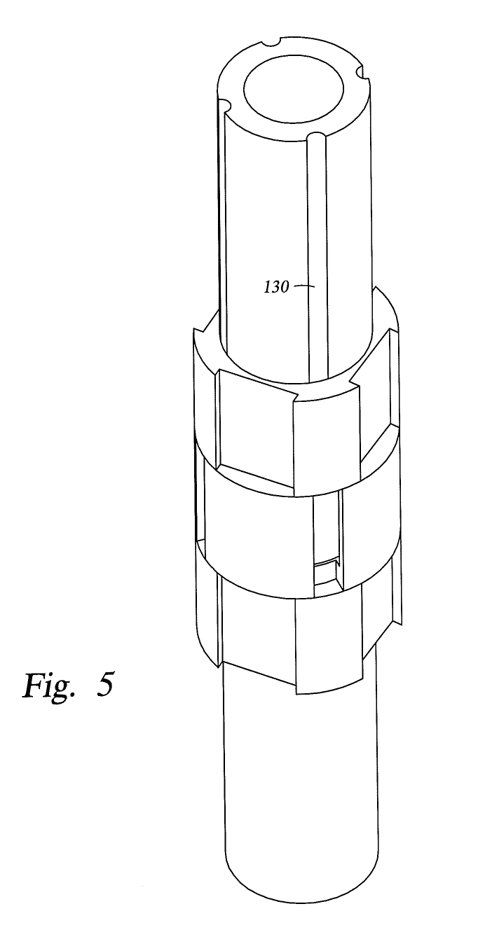

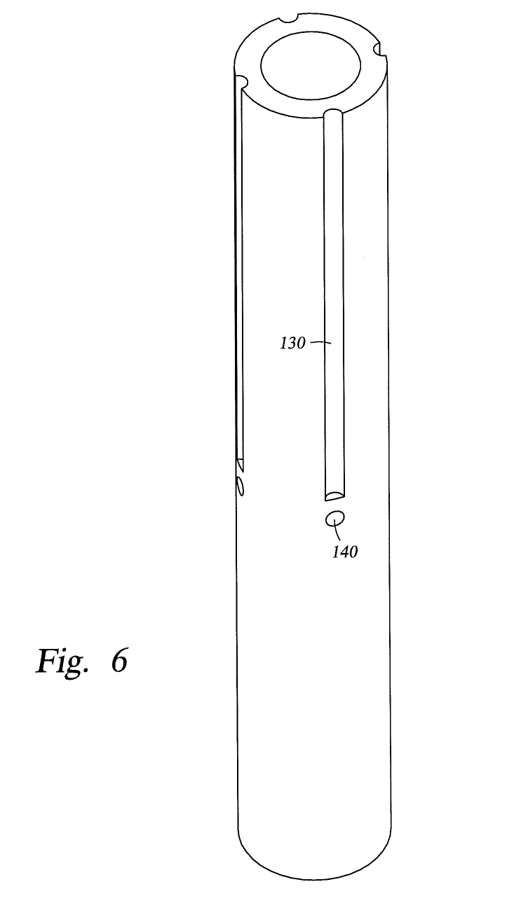

Referring to FIGS. 5 and 6 simultaneously, it is apparent that the configuration can be utilized to translate an axial flow in one or more channels 130 to a radial flow in one or more ports 114 or vice versa. The sleeve 116 is positionable as in the foregoing embodiments to either facilitate the translation or to inhibit the translation by either aligning a flow channel (which may be a machined area that is curved or squared off) at an inside dimension (“ID”) thereof to fluidly connect the channel(s) 130 to the port(s) 114. The connection can be between individual channels to individual ports or can be from multiple of either the channels or the ports to one or more of the other of the channels or the ports or channels can be connected to channels or ports can be connected to ports, as desired for a particular application. Choking control for this embodiment is also possible by providing a gradually larger translational flow area at the ID of the sleeve 116. More specifically, if a small flow area is provided between a channel and a port, there will be flow restriction. The flow path will be the most direct route between the channel and the port. This means that the larger translational flow area will be effectively dead headed so that the restriction remains the dominant flow configuration. Then, the sleeve 116 may be shifted further to allow the larger translational flow area to communicate between the channel and the port, i.e., it forms a part of that communicatory channel and is not dead headed, and the flow restriction is reduced or eliminated. In other respects, the embodiment of FIG. 5 functions as do the foregoing embodiments.

In another embodiment similar to FIG. 5, the sleeve 116 does not facilitate communication between the channel(s) and the port(s) but rather between channels or between ports. Further, another configuration mixes these two concepts to provide for more complex flow regime control.

The foregoing embodiments all operate on a principle of axial movement of the sleeve. It is to be understood that rotary actuation of the sleeve is also possible and contemplated. In such a configuration, a sleeve might include openings therethrough to allow flow when aligned with ports 14 or may have flow areas on the ID, thereof, that have a perimetrical extent such that flow around the perimeter of the valving system is facilitated or inhibited based upon the position of the sleeve. For actuation rotationally, it is important that the sources of magnetic fields (all of the configurations noted above are applicable) do not align at any stopping point of the sleeve, which also means that there must be individual sources and a whole ring structure, whether the sleeve or the electromagnets cannot be a single magnetic source. As long as the individual sources are not aligned, there will be a rotational motive force introduced upon powering of the electromagnets.

While preferred embodiments have been shown and described, modifications and substitutions may be made thereto without departing from the spirit and scope of the invention. Accordingly, it is to be understood that the present invention has been described by way of illustration and not limitation.

1. An electromagnetic valving system comprising:
a manifold having one or more flow passages therein;
a sleeve disposed relative to the manifold so that movement of the sleeve inhibits or allows fluid flow relative to the manifold; and
an electromagnet positioned relative to the sleeve such that a magnetic field generated by the at least one electromagnet produces a motive force in the sleeve.

2. The system as claimed in claim 1 wherein the sleeve comprises a magnetic field producing component.

3. The system as claimed in claim 2 wherein the magnetic field producing component is a permanent magnet.

4. The system as claimed in claim 2 wherein the magnetic field producing component is an electromagnet.

5. The system as claimed in claim 1 wherein the one or more flow passages are of the same configuration as one another.

6. The system as claimed in claim 1 wherein the one or more flow passages are of different configuration from one another.

7. The system as claimed in claim 1 wherein the one or more flow passages are positioned in axially different positions in the manifold from one another.

8. The system as claimed in claim 1 wherein the one or more flow passages are shaped to change a flow restriction depending upon the position of the sleeve.

9. The system as claimed in claim 6 wherein the different configuration is different sizes.

10. The system as claimed in claim 1 wherein the one or more flow passages include channels.

11. The system as claimed in claim 1 wherein the one or more flow passages facilitate translational flow.

12. The system as claimed in claim 11 wherein the translational flow is between axial and radial.

13. The system as claimed in claim 11 wherein the translational flow is perimetrical.

14. The system as claimed in claim 1 wherein the electromagnet is powerable selectively to produce a magnetic field having a first pole orientation or a field having a second pole orientation.

15. The system as claimed in claim 14 wherein the system further comprises a second electromagnet that is powerable with opposite polarity to the electromagnet.

16. The system as claimed in claim 1 wherein the system further includes a latch to maintain the sleeve in the selected position.

17. The system as claimed in claim 16 wherein the latch is a magnetic material.

18. The system as claimed in claim 17 wherein the latch is a magnet.

19. The system as claimed in claim 16 wherein the latch comprises a low power electromagnet.

20. A method for configuring fluid flow in a wellbore comprising:
selecting a current polarity for an electromagnet in motive force generating communication with a moveable sleeve of a valving arrangement; and urging the sleeve to a selected position that facilitates or inhibits flow.
